(19) United States
(12) Patent Application Publication
(10) Pub. No.: US 2012/0107650 A1
(43) Pub. Date: May 3, 2012

(54) MAGNETIC SEALING VALVE DEVICE FOR A BATTERY CASE

(75) Inventors: Peter Kritzer, Forst (DE); Olaf Nahrwold, Ludwigshafen (DE); Markus Clemens, Reichelsheim (DE); Hans Unger, Abtsteinach (DE); Thomas Kramer, Rimbach (DE); Ingo Stephan, Rimbach (DE); Georg Feurer, Weinheim (DE)

(73) Assignee: CARL FREUDENBERG KG, Weinheim (DE)

(21) Appl. No.: 13/023,578

(22) Filed: Feb. 9, 2011

(30) Foreign Application Priority Data
Oct. 28, 2010 (DE) 10 2010 049 649.9

(51) Int. Cl. H01M 2/12; F16K 15/03

(52) U.S. Cl. 429/53; 137/527

(57) ABSTRACT

A valve apparatus (4) is provided for a housing (2) of an electrochemical current source (1). Furthermore, the magnetic valve apparatus (4) is provided for, among other things, battery housings, fuel cell housings as well as chemical or biological reactors. As a result of using a magnetic valve apparatus (4) as an excess pressure valve, the housing (2) can be designed to operate safely even after years of use, and in addition, the valve apparatus (4) can automatically change back into the closed position after an opening and a pressure degradation and can thus build up again a protection against the penetration of fluids into the inner space (5) of the housing without external action.

### TECHNICAL AREA

The present invention relates to a valve apparatus for a housing of an electrochemical current source as well as to a housing with a magnetic valve apparatus and to an electrochemical current source with a housing comprising a magnetic valve apparatus. Furthermore, the invention relates to the use of a magnetic valve apparatus for, among other things, battery housings, fuel cell housings as well as chemical or biological reactors.

### STATE OF THE ART

Large-sized battery systems and/or other electrochemical storage reservoirs such as, for example, supercondensers are used in more and more applications. They are used in particular in back-up applications, namely, emergency current supplies. They are used, for example, in electric vehicles or hybrid vehicles, in industrial traction systems such a fork lift trucks or robots, in industrial trucks as well as in sport vehicles and recreational vehicles. Further usages are found in trains and airplanes.

In all these usages the batteries consist as a rule of a plurality of individual cells housed in a battery housing. Typical voltages of energy storage reservoirs used in this manner are up to 1000 V. Current strengths of more than 100 A are possible.

Typical lengths and widths of the battery housings are 500 mm×800 mm. The wall thicknesses of the battery housings are typically 1 to 5 mm. The battery housings are manufactured from metals, in particular steel or aluminum or from plastics, especially polyamide.

In case of an internal short circuit a development of gas can take place inside an individual cell. Typical volumes being released in a 40 Ah lithium cell are in a range of 100 L. The released gas, which consists of an electrolyte or electrolyte degradation products, is combustible and toxic.

Typically, cells open in a flexible coffee-bag design at internal pressures below 1 bar and cells with a solid, metallic casing with a cylindrical or prismatic design open at pressures of more than 10 bar.

The released gas then passes into the battery housing, where it results in a pressure rise which is a function of the dead volume in the battery housing. Furthermore, the pressure rise is a function of a possibility of a pressure loss due to leaks, for example, in the housing seal, to a transfer of the gas through pressure compensation openings that are applied in order to regulate the internal pressure of the battery in the normal state as well as to the type of cells or the rapidity of a cell opening.

During the sudden release of gases the battery housing can burst. At a dead volume of 20 L and release of 100 L gas the battery housing would be at an excess pressure of 5 bar. The combustible and toxic gas can come in contact with persons if it can pass, for example, into the inner cabin of a vehicle. The combustible and toxic gas can come in contact with current-conducting parts, which can result in an ignition or an explosion.

As a rule, the released gases are not particularly hot, so that materials of NBR or EPDM can resist the gases. In addition, upon a release of gases the seal no longer plays a part, since a valve must open. Often, there is a requirement for valves and their components for a temperature resistance of more than 500° C. and for a resistance to hydrofluoric acid.

These temperature conditions can occur in burning batteries. The normally released, relatively low amounts of hydrofluoric acid concentrations can be tolerated when using polyolefinic elastomers such as EPDM. In order to avoid extremely critical states of the entire system in the case of the cited opening of a cell each large-size battery, especially a lithium battery, must therefore have an apparatus for the safe degradation of excess pressures.

A valve for the degradation of excess pressures should not open during normal operating states. For example, pressure differences due to temperature compensation or pressure differences when travelling in mountains and valleys should not result in an opening of the valve. These typical pressure fluctuations are in a range of max.+/−0.2 bar. Moreover, a valve must prevent in any case that water can penetrate from the outside.

Therefore, especially in automobile usages elevated requirements are placed on the valve. As a rule a stream-crossing ability must be present. A tightness must be present in car-wash systems or in the case of water sprayed under high pressure. As a rule, the protective type IP 67 (“protection against water” according to DIN EN 60529 and DIN 40050 part 9) is required here. Here, the valve must be able to tolerate external excess pressures of typically 1 to 2 bar.

Furthermore, it must be prevented that parts fly around upon the opening of the valve. Therefore, in the case of an opening a moderate degradation of the excess pressure should take place. This means that an opening of valve should not take place suddenly but that the excess pressure is nevertheless degraded promptly. The entire system should be robust. It should be guaranteed that it still functions even after 10 years under “car conditions”.

Therefore, the valve should not display any aging and should not cake together upon contamination and corrosion. Typical free cross-sectional surfaces of the valve are a function of the capacity of the cells and the size of the battery. Typical cross-sectional surfaces are 5 cm² to 30 cm².

In order to solve the cited problems the battery housings of large-format lithium batteries as a rule contain a unit for degrading excess pressure. There are many designs for this.

A valve is conceivable that is controlled in conjunction with an internal pressure sensor. This has the disadvantage that this design is technically complicated and expensive, requires current, is susceptible to corrosion and is technically too complex. The principle of a rupture disc can also be used. For this, for example, thermoplastic foils are applied on openings of the battery housing. This has the disadvantage that the material can become brittle, resulting in a failure. No moderate pressure degradation is possible since a rupture disk bursts. A foil is susceptible to outer puncturing and/or injury. Furthermore, a spring valve can be used. This has the disadvantage that flying parts can not be excluded, that the spring is susceptible to corrosion and that the cross-sectional surface is limited.

### PRESENTATION OF THE INVENTION

The present invention has the basic problem of indicating an improved embodiment for a valve apparatus that is distinguished in particular by a reliable seal in normal operation and by a controlled removal of fluid produced in a problematic operation as well as by good functioning in normal operation in a problematic operation as well as after years of use.

This problem is solved in accordance with the invention by the subject matters of the independent claims. Advantageous embodiments are subject matter of the dependent claims.

A valve apparatus for a housing of an electrochemical current source with a magnetic valve apparatus is suggested as an aspect of the invention. Here, the magnetic valve apparatus comprises a closing element that closes a housing opening in a closed position in a pressure-tight manner and opens it in an open position so that fluids can escape from an inner space of the housing. Furthermore, the magnetic valve apparatus comprises at least one magnetic field producer that fixes the closing element in the closed position in a pressure-sealing manner up to a predetermined excess pressure and upon achieving or exceeding the predetermined excess pressure it allows a change of the closing element into at least one open position. This has the advantage during normal operation that the pressure-tight seal of the housing opening is ensured by a magnetic action of force. This has the considerable advantage that the force with which the closing element is fixed in the closed position in a pressure-sealing manner remains very largely constant over the time of operation. As a result, a reduction of the force during a rather long time of use can be avoided to a very great extent so that an orderly functioning of the valve apparatus can be ensured even for many years. Since the temperature range in which the at least one magnetic field producer is used, usually about 100° C. or at least 150° C. [sic—at the most?], is not exceeded or is exceeded only for a short time, a reduction of the magnetic force of the at least one magnetic field producer is not to be reckoned with, especially since this temperature range is below the Curie temperature of customarily usable permanent magnets.

Another important advantage of the magnetic design of the valve operation is the possibility of an automatic reclosing of the housing opening by the closing element by means of the at least one magnetic field producer when the closing element is moved back into the vicinity of the housing opening, for example, by gravity or a repelling tension. Thus, given a corresponding design of the valve operation, an entirely automatic, pressure-tight reclosing of the valve apparatus is possible without external action and essentially on account of the magnetic force of the at least one magnetic field producer.

The term “electrochemical current source” denotes a current source that comprises at least one electrochemical energy storage reservoir and/or at least one electrochemical energy producer. Thus, the current that can be emitted by the electrochemical current source is either produced directly prior to the emission or it was electrochemically stored in an energy storage reservoir. All currently known fuel cell variants can be considered as electrochemical energy producers, such as, for example, alkaline fuel cells (AFC), polymeric electrolyte fuel cells (PEMFC), direct methanol fuel cells (DMFC), formic acid fuel cells, phosphoric acid fuel cells (PAFC), molten carbonate fuel cells (MCFC) or solid oxide fuel cells (SOFC). The following can be used as electrochemical energy storage reservoirs: batteries or storage batteries such as, for example, lead storage batteries, nickel-cadmium storage batteries, nickel-hydrogen storage batteries, nickel-metallic hydride storage batteries, nickel-iron storage batteries, lithium-iron storage batteries, lithium-polymer storage batteries, lithium-metal storage batteries, lithium-metal polymer storage batteries, lithium manganese storage batteries, lithium-iron phosphate storage batteries, lithium-titanate storage batteries, lithium-sulfur storage batteries, zinc-sulfur-lithium storage batteries, sodium-nickel chloride high-temperature storage batteries, zinc-sulfur-lithium storage batteries, silver-zinc storage batteries, vanadium-redox storage batteries or zinc-bromine storage batteries or so-called double-layer condensers with an energy density of, for example, above 4 kWh/kg. Even several different electrochemical current producers and/or current storage reservoirs can be used as electrochemical current source in any combination. Thus, for example, it is conceivable to use a fuel cell in combination with a SuperCap or GoldCap as a double-layer condenser in order to in order to trap load peaks if necessary by means of the double-layer condenser if the fuel cell can no longer manage the accumulating load by itself.

A rise in pressure can occur in the case of aqueous electrolytes, for example, by an electrolysis in case of an overloading. Hydrogen can be released here. A rise in pressure can occur in systems with organic electrolytes by electrolysis and chemical degradation.

The term “valve apparatus” denotes in this case an apparatus that makes it possible to remove an excess pressure occurring in the housing in a controlled manner without damaging or even destroying the housing. The term “magnetic valve apparatus” denotes a valve apparatus that positions the closing element in front of the housing opening by magnetic force. The magnetic valve apparatus comprises the closing element here and at least one magnetic field producer with which the closing element is held in a pressure-sealing manner in the closed position. The term “closed position” denotes the position of the closing element in which the closing element is positioned in such a manner in front of the housing opening that the latter is closed in a pressure-sealing manner by the closing element. If the inner pressure in the interior chamber of the housing reaches or exceeds a predetermined excess pressure, the closing element is pressed away from the housing opening by the inner pressure, as a result of which the housing opening is opened and the closing element changes into an open position.

In the open position the housing opening is open in such a manner that fluids produced in the inner space of the housing can escape. The closing element can assume a predetermined open position here or change into several possible open positions.

The term “fluids” denotes gases, vapors, aerosols, very finely distributed dusts or a mixture of them.

In addition, the closing element can be designed as a flap, cover, plug, hollow plug or the like. Its shape can be designed to be round, polygonal, in particular triangular, quadrilateral, polygonal or hexagonal or oval and in the case of a hollow plug or plug it can have a conically tapering form. The closing element preferably has a stable shape and consequently can have a material thickness of 0.01 to 10 mm. For example, even a material thickness from 0.1 to 10 mm, in particular from 0.1 to 5 mm and, if necessary, from 0.5 to 5 mm are possible. A material thickness from 1 to 5 mm is preferred.

Furthermore, it can be designed to be light, stiff and/or hard. The closing element can have a density of a maximum of 8 kg/L. For example, even a density of maximally 5 kg/L, in particular of maximally 3 kg/L and, if necessary, of maximally 2 kg/L are possible. A density of maximally 3 kg/L is preferred.

Also, the closing element can be manufactured from materials such as metals, in particular aluminum and aluminum alloys, stainless steels or light-metal alloys. Moreover, it can alternatively or additionally comprise polymers, in particular as coating or be manufactured from polymers. It can also be constructed as polymer foam or closed-pore metallic foam or comprise such foams. Furthermore, the closing element can comprise auxiliary substances for increasing the electromagnetic compatibility (EMC) or be coated with them. Electrically conductive materials such as metal or electrically conductive plastics or conductive plastic modifications can be used as such auxiliary substances.

Furthermore, the closing element can be provided with an edge that surrounds a housing opening projecting out of a housing wall in such a manner that the housing opening is advantageously screened against, for example, sprayed water. The closing element can be fastened on the housing or on a frame element, as subsequently described, optionally with a hinge element, also subsequently described. The fastening of the closing element on the housing or on the frame element can be performed by adhesion, screwing, bracing, injection molding or by means of an injection-molded element.

The term “excess pressure” denotes a pressure difference between the pressure occurring outside of the housing and a pressure prevailing in the inner space of the housing. The term “pressure-tight” denotes a pressure tightness of the valve apparatus up to the predetermined excess pressure in the inner space of the housing. Furthermore, the term “pressure-tight” also denotes a tightness to the penetration and/or exiting of fluids into the inner space of the housing or out of the inner space of the housing. Thus, during normal operation a penetration of water, oil or gases from the outside into the inner space of the housing as well as an exiting of fluids from the inner space of the housing is prevented. This can advantageously prevent a short circuit of the electrochemical current source and a faulty functioning due to, for example, penetrating water.

At least one magnetic field producer can be designed as a permanent magnet or supermagnet or can be based on electrochemical induction. Materials that can be used for the permanent magnet or supermagnet can be, for example, alloys of cobalt-samarium, neodymium-iron-boron, aluminum-nickel cobalt and/or hard ferrites based on barium or strontium. Furthermore, the materials used for producing the permanent magnet or supermagnet can have a Curie temperature above 100° C. For example, even a Curie temperature of more than 110° C., in particular more than 120° C. and optionally more than 130° C. are possible. A Curie temperature of more than 140° C. or 150° C. is preferred. This can ensure that the proper functioning of the magnetic field producer is not lost even after many years of use.

The magnetic field producer can be constructed as a magnetic polymer. For this, for example, a permanent magnet can be in powdery form or otherwise distributed more or less extremely finely in the polymer. In this case the magnetic polymer can be present as open-pore and/or closed-pore foam. Furthermore, the construction of the magnetic field producer is also conceivable as a permanent magnet or supermagnet of a solid material. Magnetic bands and/or magnetic papers can also be used as magnetic field producers. Furthermore, the magnetic field producer can also be designed at the same time as a detent—stopper. The magnetic field producer can be designed areally or also be used only in a punctiform manner.

The counter-structural element that experiences a magnetic action of force together with the at least one magnetic field producer can also be designed as a magnetic field producer, can comprise such a magnetic field producer or can be constructed from a magnetic or magnetizable material that can be attracted by the at least one magnetic field producer. Iron, soft iron, steel, in particular with a low carbon content, steel with an additive of silicon or other steel types as well as nickel-iron alloys, cobalt-iron alloys or other alloys such as ferrite or a mixture of the same can be used for such a counter-structural element of magnetic or magnetizable material. Furthermore, the magnetic field producer can be completely surrounded by a resistant material such as, for example, a polymer material, so that a destruction of or damage to the magnetic field producer by corrosion is advantageously prevented or can be reduced as a result. Even the counter-structural element, that together with the magnetic field producer builds up the magnetic action of force, can also be completely encased by, e.g., a polymer material for protection from destruction such as corrosion.

The magnetic field producer can already be used completely magnetized during the assembly of the valve apparatus or a magnetization of the appropriate structural element can also be performed after the assembly. One or more magnetic field producers can be used that build up a magnetic action of force with one or more counter-structural components consisting of the appropriate magnetic or magnetizable material. However, several magnetic field producers can also be used additionally or alternatively in such a manner that the magnetic action of force results between at least two magnetic field producers, which force fixes the closing element in a pressure-sealing manner in front of the housing opening. Thus, it is conceivable that the closing element itself is constructed as a magnetic field producer, thus, for example, as a magnetic polymer, coated with a magnetic foil, or otherwise provided with magnetic field producers. Furthermore, at least one magnetic field producer can also be fastened on the housing or on the frame element. It is also conceivable that the housing and/or the closing element consist/s of a magnetic or magnetizable material that makes the desired magnetic action of force possible together with a magnetic field producer. Furthermore, each and any combination of the above-described embodiments regarding the magnetic action of force and regarding the corresponding counter-structural component-magnetic field producer pairings is admissible.

The form of the magnetic field producers can be cylindrical, parallelepipedic, band-shaped, areal or distributed in a punctiform manner. It is also conceivable to use a magnetic field producer that functions on the basis of electromagnetic induction. Since an electrical current source is arranged in the housing, it is conceivable to form at least one electrical conduction section in such a manner that an electromagnetic induction can be carried out with the aid of the current flowing in the electrical conduction section. With the aid of the electromagnetic induction a magnetic field can be generated with the aid of which a magnetic action of force can be generated between the closing element and another component of the valve apparatus and/or between the housing.

The predetermined excess pressure after which the closing element changes from the closed position into the open position can be selected to be 2 to 8 times larger than a maximum excess pressure occurring during a normal operation in the inside space of the housing. As a consequence, the closing element can remain during a normal operation in the closed position and upon the development of fluids, in particular during a faulty operation of the electrochemical current source, can change into at least one open position.

If a change of the closing element takes place from the closed position into one of the open positions only after a distinctly elevated excess pressure, it can be advantageously prevented that an opening of the valve apparatus occurs during a normal operation of the electrochemical current source. Consequently, in this operating state the inner space of the housing is also protected against any entering fluids. In this manner a sufficient operating safety can be ensured during normal operation without damage or destruction of the housing having to be accepted in any occurring faulty operation due to due to fluids developing in the interior space of the housing.

As a consequence, the valve apparatus can be constructed in such a manner that pressure fluctuations are tolerated in a range from +/−0.5 bar without opening the valve apparatus. For example, even pressure fluctuations of +/−0.4 bar, in particular +/−0.35 bar and, if necessary, +/−0.3 bar can also be tolerated. A tolerance to pressure fluctuations of +/−0.2 bar is preferred.

This is ensured by a magnetic action of force that makes an opening of the closing element possible when the predetermined excess pressure in the interior space of the housing reaches an excess pressure of 0.5-1.0 bar. For example, even a predetermined excess pressure of 0.55-1.0 bar, in particular 0.55-0.9 bar, and, if necessary, 0.55-0.8 bar are possible. A predetermined excess pressure of 0.6-0.8 bar is preferably adjusted.

Characteristic pressure values for special applications are indicated in the following table.

| | | |
|---|---|---|
| Use | Maximum excess | Maximum underpressure |
| | pressure | at p batt < p outer |
| | at p batt > p outer | |
| Car | about 0.2 bar | 0.2 bar |
| | (temperature | 2 bar (water, |
| | compensation, air | stream-crossing ability) |
| | pressure, mountain and | |
| | valley travel | |
| Airplane | about 1 bar | about 1 bar |
| Backup | takeoff and landing | takeoff and landing |
| (emergency current) | procedures | procedures |
| Train | about 0.5 bar | about 0.5 bar |
| Backup | like car, tunnel travel | like car, tunnel travel |
| (emergency current) | | |
| Stationary | 0.2 bar | 0.2 bar |
| Backup | | |
| (emergency current) | | |

For example, the predetermined excess pressure above which the closing element changes from the closed position into the open position can be selected to be 2 to 6 times greater than a maximum excess pressure that occurs during a normal operation in the inner space of the housing, in particular 3 to 6 times greater and, if necessary, 3 to 5 times greater. The predetermined excess pressure is preferably 2 to 5 times greater.

Such excess pressures, especially maximum excess pressures, occurring in normal operation can arise as a consequence of a temperature compensation or in case of electric vehicles during mountain and valley travel. The maximum excess pressure during normal operation is to be understood as the excess pressure that can occur as maximum value. A normal operation is to be understood as the operation of the electrochemical voltage source that is not characterized by a problem. If, on the other hand, a problem occurs such as, for example, the bursting of one of the components of the electrochemical current source, than this operating state is called a problematic operation. In the case of a problematic operation fluid developments can occur that can exceed five times the free dead volume in the inner space of the housing. In the case of such fluid developments destruction of or damage to the housing can occur if the fluids becoming free are not removed in a controlled manner from the housing.

Furthermore, the valve apparatus can comprise a hinge element with which the closing element can be held in the particular open position.

The positioning and/or the guided movement of the closing element in the area of the housing opening are advantageous when using a hinge element. In addition, such a hinge element can prevent a bursting off of the closing element and its being slung away from the housing, so that no danger of injury or damage threatens in case of a problem by virtue of the closing element fastened by the hinge element. Damage could occur if a cable is cut through. In addition, given an appropriate positioning of the closing element, an automatic closing after a pressure degradation has taken place can be brought about in an advantageous manner, whereby the closing element can be moved back into the closed position by, for example, gravity, so that after the pressure degradation that took place the valve apparatus closes in a self-acting and automatic manner. In addition, the hinge element can advantageously be built up in a very simple manner, so that it is simple in construction and economical to manufacture.

In order that the closing element can not be slung away during the opening of the housing opening the hinge element is preferably to be constructed in such a manner that it is resistant to being torn by sudden mechanical loading. In addition, it is advantageous if the hinge element contributes to sealing the housing opening or at least does not hinder the sealing of the housing opening in a counterproductive manner. The hinge element can be designed as a mechanically stable thermoplastic foil and/or as a seal, in particular as an injection-molded seal. It can be constructed integrally with the closing element and/or with the frame element, to be described subsequently, and injection-molded, for example, with an injection-molding process onto the closing element, the frame element and/or the housing. Consequently, it can consist of current, in particular elastomeric polymers. Furthermore, even the construction of the hinge element as a hinge in the traditional sense is conceivable, whereby in this case the hinge element can consist of plastic and/or metal or can comprise these materials.

Additionally, the hinge element can stand under a certain tension, so that after the change of the closing element from the closed position into the open positions and after the pressure release of the inner space of the housing has taken place the closing element is pressed back into the closed position on account of the tension of the hinge element. As a consequence, the hinge element contributes only in a negligible manner to the pressing of the closing element onto the housing opening, so that the closing element is pressed in a pressure-tight manner onto the housing opening substantially by the magnetic action of force. However, an automatic, independent reclosing of the housing opening after the pressure release can be advantageously made possible by the tension of the sealing element.

Furthermore, the valve apparatus can comprise a frame element with which the valve apparatus can be fastened to the housing.

The housing opening can be advantageously designed in such a manner by using a frame element that a pressure-tight closure of the housing opening can be ensured.

The frame element can be designed to be integral with the housing or as a structural component that can be separately set into the housing opening. In the case of an integral design with the housing the frame element can be manufactured from the housing with an appropriate modification process such as, for example, stamping, press modification, optionally at elevated temperature, flanging or the like. It is also conceivable to injection-mold the frame element onto the housing opening by an injection-molding process, whereby in this case materials such as polymers, metals or ceramics can be used for the material. In the case of ceramics an insulation of the housing opening can be made with advantage.

If the frame element is constructed as a separate structural component, then it and optionally even the entire valve apparatus, if the valve apparatus is defective, can be readily replaced. Thus, the frame element can be constructed in a single part or in several parts. In order to fasten the frame element in the housing opening the frame element can comprise a circumferential groove running in the plane of the opening which groove surrounds the housing opening on both sides and can be designed to be partially interrupted. The frame element can be fixed in the housing opening with the aid of this circumferential groove. It is also possible to design the frame element in at least two parts, whereby at least one part of the frame element is arranged outside of the housing whereas at least one second part of the frame element is positioned inside the housing. The frame element can be fixed in the housing opening by connecting the two parts of the frame element by, for example, engagement, clipping, adhering, welding or the like. For the sealing a seal can be applied between the frame element and the housing wall on one side or both sides or the frame element can be adhered or welded to the housing.

Furthermore, the frame element can be formed as an independent structural component or also formed from the housing, and can comprise a groove open to the outside and at least partially circumferential into which a sealing element to be subsequently described can be inserted. Furthermore, the frame can also comprise further recesses for receiving magnetic field producers.

The valve apparatus can comprise at least one sealing element. If a sealing element is used, a constructively simple tightness of the valve apparatus can be ensured with the aid of the sealing element. The closing element can be pressed onto the sealing element by the magnetic action of force in such a manner that the valve apparatus is closed in a pressure-tight manner up to a predetermined excess pressure in the inner space of the housing. In addition, the use of the sealing element can also prevent fluids from being able to penetrate from the outside into the inner space of the housing. In this manner, for example, the requirements of protective class IP 67 can be met with this apparatus.

The material of the sealing element advantageously has a resistance to cleaning agents like those used, for example, in car wash systems and/or to oil components. On the other hand, a tolerance compensation of the material of the closing element relative to the frame element or to the housing can also be achieved by the sealing element. This tolerance compensation can also optionally take into consideration the different coefficients of thermal expansion. The sealing element can be constructed in the manner of a sealing ring or in the manner of a molded structural component. Even the forming of the sealing element as a sealing lamella or sealing lip is conceivable. In addition, even more than one sealing element can be used, thus, for example, a sealing ring and, in addition to the sealing ring, circumferential sealing lamellae or sealing lips.

The sealing element can be arranged in a groove, as previously described, and consequently in a groove on the frame element or in a groove formed on the housing as well as directly applied, for example, injection molded. on the frame element or on the housing. Furthermore, it is also conceivable to arrange the sealing element on the closing element or to use any combination of the previously described arrangements and embodiments.

The sealing element can be constructed as a vulcanized-on elastomer, as an elastomer applied with a bead process, as extruded, thermoplastic elastomer (TPE), thermoplastic polyurethane (TPU), adhered-on elastomer, adhered-on thermoplastic elastomer, as solid material or as closed-pore foam.

In the case of a construction as elastomer, elastomers such as nitrile-butadiene rubber (NBR), hydrogenated nitrile-butadiene rubber (HNBR), ethylene-propylene-diene rubber (EPDM), fluorine rubber (FKM), acrylate rubber (ACM), or silicon rubber (VMQ) can be used.

The material of the sealing element can comprise magnetic particles. The magnetic material is advantageously protected at least against corrosion by the embedding of magnetic particles in the sealing element. Even metallic particles can be incorporated in the sealing element with which particles the magnetic field producers can then enter into an interaction. In any case, it is conceivable that the sealing element contains electrically conductive particles or is designed as an electrically conductive plastic. As a result, an exiting and/or an entrance of interference fields out of the inner space of the housing or into the inner space of the housing is/are at least reduced. Consequently, the EMC compatibility can also be elevated by the sealing element.

The valve apparatus can comprise a tensioning element with which the closing element can be moved from the at least one opening position into the closed position.

The closing element can be guided in a controlled manner from an open position back into the closed position by using a tensioning element.

On the one hand, it is possible to position the valve apparatus on the housing in such a manner that such a return guiding of the closing element from an open position into the closed position can also be achieved by gravity. This can be additionally supported, as previously described, by a hinge element standing under tension. However, a tensioning element can be additionally or alternatively provided with which the closed position can be moved from an open position into the closed position. Such a tensioning element can be formed as a spring element or as an expansion element. Thus, if the closing element is brought from the closed position into an open position by reaching or exceeding the predetermined excess pressure, then in this instance the tensioning element is put under tension in such a manner that the mechanical energy stored in the tensioning element brings it about that the closing element is guided back from an open position into the closed position. Once this takes place, the magnetic action of force can bring it about on account of the advantageous distance of the closing element to the housing opening that the closing element is pressed onto the housing opening. Consequently, the tensioning element can be manufactured from materials such as metals or elastomers.

In addition, the valve apparatus can comprise a sensor element with which an occurred opening of the closing element can be indicated.

An occurred opening of the closing element and/or of the valve apparatus can advantageously be indicated by using a sensor element.

The sensor element can be constructed optically, haptically, acoustically and/or electrically. In the case of the optical construction of the sensor element the sensor element can optically communicate to a user, for example, as a result of a color change or the like, that the valve apparatus was opened. Furthermore, such an opening of the valve apparatus can be indicated by a haptic signal or, in the case of escaping gases, acoustically, for example, by a whistling. The sensor element can also be electrically constructed, so that an opening of the closing element can be indicated to a signal processing apparatus. The signal processing apparatus can be, for example, the engine control or the on-board electronic system of a motor vehicle.

An especially simple sensor element is a seal that indicates a valve “in an open state”.

Furthermore, the valve apparatus can comprise at least one damping element with which an action of force can be damped upon a change of the closing element between the positions.

Destructions or damage to the valve apparatus and/or to the housing can advantageously be avoided when using a damping element on account of the occurring actions of force that can develop upon the exiting of fluids produced in the inner space of the housing. The damping element can be designed as foam on the housing, the frame element and/or on the closing element. Thus, when a hinge element is used, a flattering or clapping of the closing element is mitigated in such a manner that damage to the housing or to the closing element can be avoided. Likewise, in the case of a closing of the closing element a damping of the closing process can be achieved on account of the magnetic action of force by the using of a damping element. It is also conceivable that the sealing element also assumes such a damping of the operation in addition to or alternatively to the damping element.

In addition, the valve apparatus can comprise a stabilizing element with which, among other things, the frame element can be stabilized, in particular against mechanical deformations.

The frame element can be advantageously stabilized, in particular against mechanical deformations, by the insertion of a stabilizing element into the frame element. In addition, given a metallic construction of the stabilizing element a magnetic action of force can be present between the stabilizing element and the at least one magnetic field producer. Furthermore, the tensioning element can be advantageously connected to the stabilizing element so that in the case of a changing of the closing element from the closed position into an open position mechanical energy can be stored in the tensioning element for reclosing the housing opening. The stabilizing element is preferably fastened in or on the frame element or it is integrally constructed with it. The stabilizing element is preferably arranged in the frame element projecting into the inner space of the housing. Such a stabilizing element can also be constructed from the housing material by appropriate modification processes. Accordingly, the stabilizing element can be inserted into the frame element or the frame element into the stabilizing element.

The valve apparatus can comprise a filter element with which exiting fluids can be filtered.

A filter element can advantageously free exiting fluids from components damaging to the environment. The filter element can be formed as a fleece, a solid-body fill or the like. It can bind or absorb damaging components of the exiting fluids. Consequently, it can comprise activated carbon, drying agents, acid binders, lye binders or the like.

The valve apparatus can be provided with a coupling element to which a discharge line for the exiting fluids can be coupled.

Any exiting fluids can be advantageously removed to a target area by the coupling element and a removal line connected to the coupling element if any effects of the fluids are damaging and hazardous.

Thus, the coupling element can be constructed as a pipe, hose, connecting piece, in the manner of a bayonet catch, as a screw connection, plug connection or the like. If a removal line is used it is also conceivable that the valve apparatus is not attached to the housing itself but rather is positioned in the removal line at a distance from the housing.

In another aspect of the invention a housing for an electrochemical current source with a magnetic valve apparatus is suggested. The magnetic valve apparatus can be constructed as previously described.

A housing for an electrochemical current source can be constructed to be safe in operation even in a problematic operation by means of a magnetic valve apparatus like the one previously described. This housing can be closed in a pressure-tight manner during a normal operation so that any fluids occurring in the outer area of the housing can not pass into the inner space of the housing, since the valve apparatus, that tolerates rather small fluctuations in pressure, does not open until a predetermined excess pressure is achieved or exceeded in the inner space of the housing. In addition, the housing is constructed with a simple construction in spite of its high operational safety and is safe from destruction even in a problematic situation since, in addition, no exploded-off parts can cause damage, and it is, in addition, designed not to be subject to disturbances in normal operation as well as in a problematic operation since the magnetic action of force is weakened only to a slight, negligible extent even after long years of use.

The housing can serve to receive an electrochemical current source. Consequently, the housing can also comprise, in addition to the valve apparatus, electrical connection apparatuses and optionally connection apparatuses for a cooling system. In addition, cooling lines for cooling the electrochemical current source can be arranged in the housing, in the housing wall and/or outside on the housing. Furthermore, the housing can also have further openings via which the individual components of the electrochemical current source can be installed into the housing or removed from the housing. Such housings for an electrochemical current source can be manufactured from metal, metal alloys and/or plastics. Steel, aluminum, aluminum alloys or the like can be used as metals. Polyamide or polybutylene terephthalate have proven themselves as plastic materials. The wall thickness of the housing can be 1 to 10 mm thick and have an inside volume of 1 to 1000 L.

A ratio of opening cross section/dead volume of the inner space of the housing can be at least 0.2 cm²/L.

A gentle removal of the fluid being produced in the inner space of the housing and standing under excess pressure can be ensured by an appropriate ratio of opening cross section/dead volume of the inner space of the housing.

In addition, an easy removal of the fluids from the inner space of the housing is also made possible with such opening cross sections. Thus, gases being released in the case of an internal short circuit in, for example, a 40 Ah storage battery have volume in the range of 100 L. Given a possible dead volume of 20 L of a housing that can be used in this range, an excess pressure of 5 bar would build up very rapidly. The previously described valve apparatus will release at an earlier pressure; however, it is advantageous due to the amount of fluids being produced to dimension the housing opening in such a manner that a gentle and easy removal of the fluids being produced in the inner space of the housing is possible.

The term “dead volume of the housing” means the volume that is freely available and is not taken up by components of the electrochemical current source. Thus, the dead volume is the volume in the inner space of the housing in which the fluids being produced can collect and/or reside.

An electrochemical current source with a housing comprising a magnetic valve apparatus is suggested as another aspect of the invention. The magnetic valve apparatus and/or the housing can be constructed as previously described.

An electrochemical current source that is provided with such a housing is also safe in operation during a problematic operation since in the case of a problem in the electrochemical current source regarding the developing fluids the removal of them is designed to be controllable. In addition, after the occurrence of such a problem the further operational safety regarding the penetration of fluids into the inner space of the housing is ensured in a constructively simple and reliable manner.

Another aspect of the invention can be the use of a magnetic valve apparatus for housings, in which pressure fluctuations can occur, for chemical reactors, for battery housings, for double-wall condenser housings or for fuel cell housings. The magnetic valve apparatus can be designed here as previously described.

Such magnetic valve apparatuses can advantageously be used in housings for electrical current sources but also in the area of chemical or biochemical reactors. In principle, the use in all areas is conceivable in which a pressure buildup can result in the destruction of the housing or of the apparatus due to fluids being produced, which can be avoided by the magnetic valve apparatus. A controlled removal of the gases can be achieved here without endangering the environment by means of such a magnetic valve apparatus.

Furthermore, the use in transport containers for new and in particular used/defective cells or batteries is possible. It must be ensured in this case that in the release of gases due to a problematic situation the following, subsequent pressure rise does not result in a bursting of the transport container. This is especially risky when cells or batteries are transported with an airplane.

### SHORT DESCRIPTION OF THE SCHEMATIC DRAWINGS

The drawings schematically show:

FIG. 1 shows an electrochemical current source with a housing and with a magnetic valve apparatus;

FIG. 2 shows a magnetic valve apparatus with a closing element, a frame element, a sealing element and a magnetic field producer;

FIG. 3 shows an arrangement of the sealing element and of the magnetic field producer on a frame element;

FIG. 4 shows a section through the frame element in the area of the housing opening;

FIG. 5 shows the closing element connected to the frame element via a hinge element;

FIG. 6 shows the magnetic valve apparatus with a circumferential sealing element on the closing element;

FIG. 7 shows the valve apparatus with several magnetic field producers arranged in a punctiform manner;

FIG. 8 shows the valve apparatus with a sealing element constructed as a magnetic field producer;

FIG. 9 shows an arrangement of the sealing element constructed as a magnetic field producer on the frame element;

FIG. 10 shows the magnetic valve apparatus with a metallic stabilizing element,

FIG. 11 shows the magnetic valve apparatus with annular or punctiform magnetic field producers and with the metallic stabilizing element,

FIG. 12 shows a three-dimensional illustration of the embodiment shown in FIG. 10 and FIG. 11;

FIG. 13 shows a possible excess pressure course in an inner housing space of the housing; and

FIG. 14 shows a possible construction of a magnetic field producer, for example, for the embodiments shown in FIG. 10 to FIG. 12.

### IMPLEMENTATION OF THE INVENTION

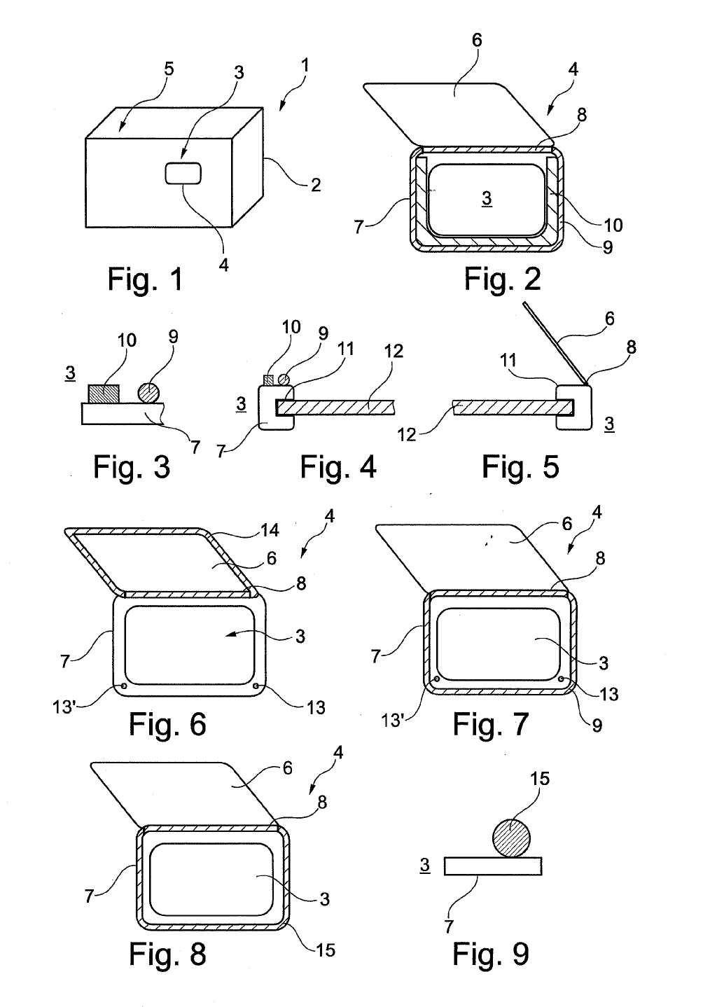

FIG. 1 shows an electrochemical current source 1 that is provided with a housing 2 in whose housing opening 3 a magnetic valve apparatus 4 is inserted. Electrochemical current source 1 can comprise as component at least one electrochemical current producer and/or at least one electrochemical energy storage reservoir, whereby the components of electrochemical current source 1 are arranged in an inner space of the housing 5.

The magnetic valve apparatus 4 shown in FIG. 2 comprises a closing element 6 constructed as a cover or a flap. Furthermore, magnetic valve apparatus 4 is provided with a frame element 7 with which magnetic valve apparatus 4 can be fixed in housing opening 3. Furthermore, closing element 6 is connected to frame element 7 via a hinge element 8, whereby hinge element 8 is constructed in such a manner that closing element 6 can be folded away from housing opening 3 and consequently opens housing opening 3 or frees it.

In addition, magnetic valve apparatus 4 is provided with a sealing element 9 and a magnetic field producer 10. Magnetic field producer 10 is positioned between sealing element 9 and housing opening 3 on frame element 7. However, an inverted arrangement of sealing element 9 and of magnetic field producer 10 relative to one another is also conceivable. Sealing element 9 and magnetic field producer 10 are firmly connected to frame element 7. Frame element 7 can comprise one or more grooves, that are not shown in FIG. 2, in which sealing element 9 and/or magnetic field producer 10 is/are inserted. Sealing element 9 can be constructed as an elastomer whereas magnetic field producer 10 can be constructed as a magnetic band, magnetic foil or the like. Sealing element 9 can be arranged circumferentially on frame element 7 or ensure, together with hinge element 8, a pressure tightness of the valve apparatus.

FIG. 3 shows the arrangement of a possible embodiment of sealing element 9 and of magnetic field producer 10 on frame element 7. Thus, sealing element 9 can be constructed round in cross section whereas magnetic field producer 10 can have an angular, especially rectangular cross section.

The frame element 7 shown in FIG. 4 has a circumferential groove 11 with which frame element 7 can be positioned and fixed in housing opening 3. In the inserted position circumferential groove 11 is filled out at least partially by a housing wall 12.

For further clarification, FIG. 5 shows frame element 7 with its circumferential groove 11 and with closure element 6 connected via hinge element 8 in the inserted position to housing opening 3, whereby housing wall 12 again fills out circumferential groove 11.

The embodiment of a magnetic valve apparatus 4 shown in FIG. 6 comprises a frame element 7 connected via a hinge element 8 to closing element 6. Several punctiform magnetic field producers 13, 13′ are arranged in frame element 7 and the closing element 6 is provided with a sealing element 14. In this embodiment sealing element 14 is preferably constructed as a sealing lip or sealing lamella. In this embodiment the material of closing element 6 is to be selected in such a manner that a magnetic action of force can occur between punctual magnetic field producers 13, 13′ and closing element 6.

The magnetic valve apparatus 4 shown in FIG. 7 also has a frame element 7 that is connected via a hinge element 8 to a closing element 6. Several punctiform magnetic field producers 13, 13′ are positioned in frame element 7 that can form a magnetic action of force together with closing element 6. Consequently, even in this embodiment closing element 6 must be manufactured from an appropriate material. Furthermore, a sealing element 9 is arranged on frame element 7 with the aid of which sealing element a pressure-tight closure of housing opening 3 can be ensured.

FIG. 8 shows a magnetic valve apparatus 4 that also comprises a frame element 7 that is connected by a hinge element 8 to closing element 6. A magnetic sealing element 15 is positioned on frame element 7 which sealing element functions both as a sealing element and as a magnetic field producer. Consequently, even in this embodiment a magnetic action of force occurs between magnetic sealing element 15 and closing element 6, whereby closing element 6 must be manufactured from an appropriate material. Sealing element 15 can therefore comprise permanent magnet material.

FIG. 9 shows the arrangement of sealing element 15 on frame element 7. Sealing element 15 has a round cross section. In this instance the components generating the magnetic field are integrated into the sealing element.

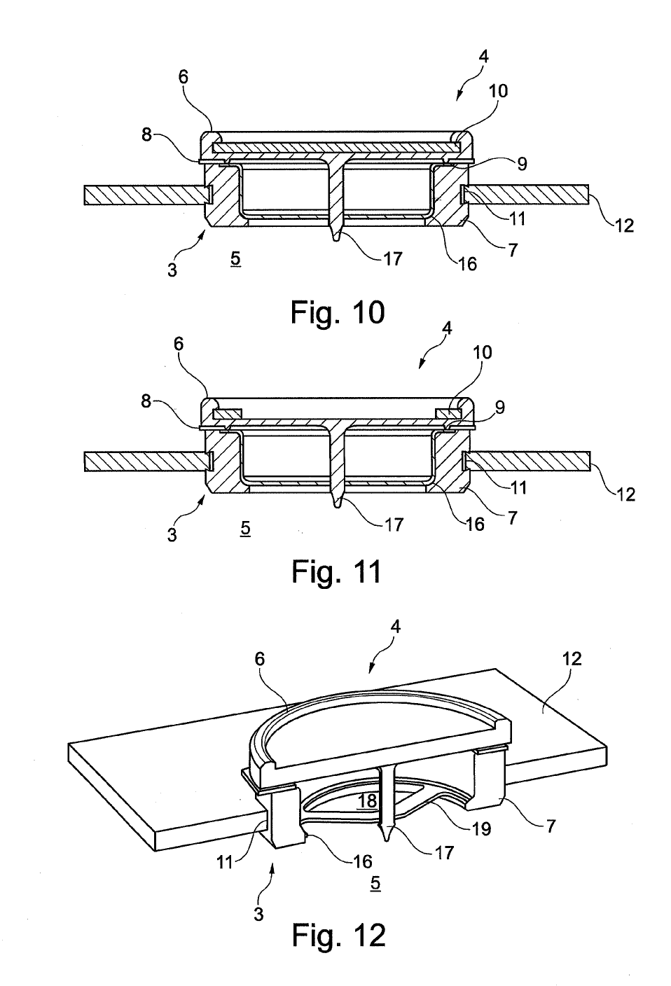

FIG. 10 shows a magnetic valve apparatus 4 in the inserted position with housing opening 3. The magnetic valve apparatus is provided with a frame element 7 that comprises a circumferential groove 11 that is filled out by the housing wall 12. Also, magnetic valve apparatus 4 comprises a closing element 6 connected via a hinge element 8. Furthermore, a sealing element 9 is arranged on closing element 6 which sealing element is constructed in the shape of a sealing lip or sealing lamella. A stabilizing element 16 is set into a frame element 7 which stabilizing element is preferably constructed from metal. Closing element 16 is provided with a magnetic field producer 10. In this embodiment the magnetic action of force occurs between magnetic field producer 10 and stabilizing element 16. Furthermore, closing element 6 is connected to stabilizing element 16 by tensioning element 17 in the form of a nipple. If closing element 6 changes from its closed position into an open position, then tensioning element 17 is put under tension. After the pressure degradation has taken place, tensioning element 17 moves closing element 6 from the open position back into its closed position. In the closed position valve apparatus 4 is again closed in a pressure-tight manner on account of an action of force occurring between magnetic field producer 10 and stabilizing element 16.

FIG. 11 shows an embodiment that differs from the embodiment of FIG. 10 in that no areal magnetic field producer 10 is used but rather a magnetic field producer 10 in the shape of a perforated disk or punctiform magnetic field producers 13, 13′.

FIG. 12 shows the magnetic valve arrangement 4 of FIGS. 10, 11 three-dimensionally in order to better illustrate the insertion position of magnetic valve apparatus 4. It can be determined that stabilizing element 16 is constructed in such a manner that it comprises several recesses 18 oriented toward inner housing space 5. On account of these recesses 18 fluids produced inner space of the housing 5 can flow out through stabilizing element 17. On account of the recesses and in order that tensioning element 17 can be connected to stabilizing element 16, several webs 19 are formed that run together in the middle of housing opening 3 so that tensioning element 17 can be connected to stabilizing element 16 at the connection point of webs 19.

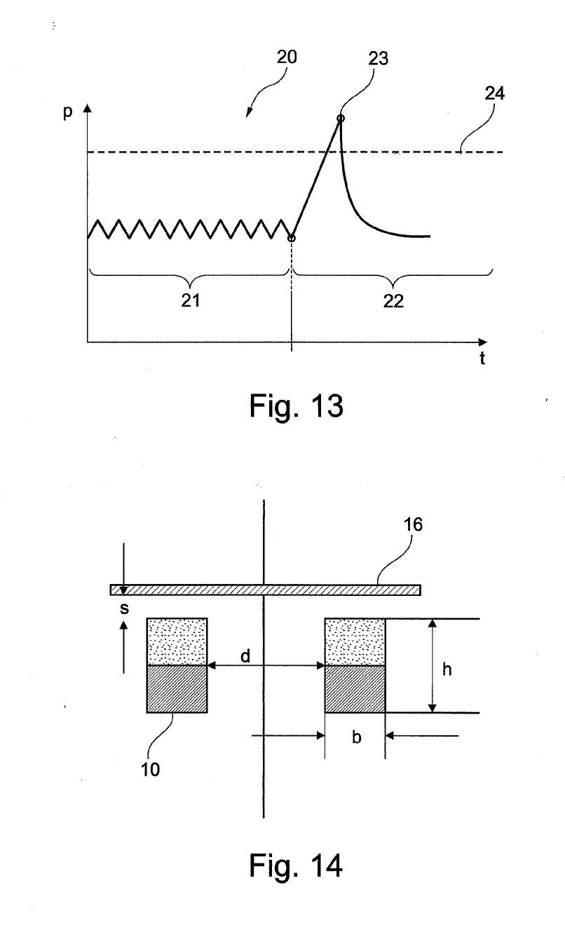

FIG. 13 illustrates a possible pressure course 20 in inner space of the housing 5. It can be gathered from pressure course 20 that in a normal operation 21 rather small pressure fluctuations can occur. Consequently, magnetic valve apparatus 4 is constructed in such a manner that it tolerates such pressure fluctuations occurring in normal operation 21 without opening. However, a pressure fluctuation 23 occurring in a problematic operation 22 in contrast to normal operation 21 can become so great that it reaches or exceeds a predetermined excess pressure 24 above which the magnetic valve apparatus 4 changes from its closed position into an open position. In this instance magnetic valve apparatus 4 opens and the fluid produced in inner space of the housing 5 can escape in a controlled manner without destruction of or damage to housing 2 occurring. After the opening of magnetic valve apparatus 4 the pressure can still briefly rise but then drops to the normal level.

FIG. 14 shows a possible embodiment of a magnetic field producer 10 for the embodiment of a magnetic valve apparatus 4 shown in FIG. 11. Here, magnetic field producer 10 is constructed in an annulus and arranged at a distance from metallic stabilizing element 16 with distance s due to sealing element 9 not shown in FIG. 14. Annular magnetic field producer 10 has a height h, a width b of the ring and an inside diameter d. In order that magnetic field producer 10 exerts a sufficiently high magnetic action of force on stabilizing element 16, the magnetic material of magnetic field producer 10, the amount of magnetic material in magnetic field producer 10, that can be constructed as a magnetic polymer, the width b, the height h and the distance s can be varied.

The following exemplary embodiments show variations of the previously described magnetic field producer 10 and the results following from them. The values for the forces are mathematically determined.

### Example

### Variation of the Magnetic Field Producer According to FIG. 14

A ring with an inside diameter d of 36 mm is used. F1 is the force up to which the magnetic valve apparatus is closed and F2 is the force after which an opening occurs. “−” signifies a negative result and “+” signifies a positive result.

### Materials Used (Remanences in mT):

1 barium ferrite isotropic (210)
2 barium ferrite isotropic (390)
3 strontium ferrite anisotropic (350)
4 AlNiCo 500 samarium cobalt SM 18 (1120)
5 SmCo₅ samarium cobalt SM 24 (850)
6 Sm₂Co₁₇ (100)
7 neodymium-iron-boron NdFeB (1180)

| | Amount | h | b | s | | | |
|---|---|---|---|---|---|---|---|
| Material | [%] | [mm] | [mm] | [mm] | F1 | F2 | Result |
| 1 | 70 | 4 | 6 | 0.1 | 2 | 3 | − |
| 2 | 70 | 4 | 6 | 0.1 | 7 | 8 | − |
| 3 | 70 | 4 | 6 | 0.1 | 6 | 7 | − |
| 6 | 70 | 4 | 6 | 0.1 | <<1 | 1 | − |
| 4 | 50 | 4 | 6 | 0.1 | 34 | 35 | +/− |
| 4 | 70 | 4 | 6 | 0.1 | 65 | 70 | + |
| 4 | 70 | 4 | 6 | 0.3 | 50 | 55 | + |
| 4 | 70 | 4 | 4 | 0.3 | 40 | 45 | + |
| 5 | 50 | 4 | 6 | 0.1 | 19 | 20 | − |
| 5 | 70 | 4 | 6 | 0.1 | 38 | 40 | + |
| 5 | 70 | 4 | 6 | 0.3 | 30 | 35 | +/− |
| 5 | 70 | 4 | 4 | 0.3 | 23 | 25 | − |
| 7 | 50 | 4 | 6 | 0.1 | 38 | 40 | +/− |
| 7 | 70 | 4 | 6 | 0.1 | 74 | 80 | + |
| 7 | 70 | 4 | 6 | 0.3 | 58 | 59 | + |
| 7 | 70 | 4 | 4 | 0.3 | 45 | 50 | + |

1. A valve apparatus for a housing (2) of an electrochemical current source (1) with a magnetic valve apparatus (4), comprising a valve closing element (6) that closes a housing opening (3) in a closed position in a pressure-tight manner and opens it in an open position so that fluids can escape from an inner space (5) of the housing, and with at least one magnetic field producer (10, 13, 13′) that fixes the closing element (6) in the closed position in a pressure-sealing manner up to a predetermined excess pressure in the inner space (5) of the housing, and upon achieving or exceeding the predetermined excess pressure it allows a change of the closing element (6) into at least one open position.

2. The valve apparatus according to claim 1, whereby the predetermined excess pressure (24) after which the closing element (6) changes from the closed position into the open position is selected to be 2-8 times larger than a maximum excess pressure occurring during a normal operation (21) in the inside space (5) of the housing, so that the closing element (6) remains during a normal operation (21) in the closed position and upon the development of fluids or gases, in particular during a faulty operation (22) of the electrochemical current source (1), it changes into at least one open position.

3. The valve apparatus according to claim 1, whereby the valve apparatus (4) comprises a hinge element (8) with which the closing element (6) can be held in the particular open position.

4. The valve apparatus according to claim 1, whereby the valve apparatus (4) comprises a frame element (7) with which the valve apparatus (4) can be fastened to the housing (2).

5. The valve apparatus according to claim 1, whereby the valve apparatus (4) comprises at least one sealing element (9, 14, 15).

6. The valve apparatus according to claim 1, whereby the valve apparatus (4) comprises a tensioning element (17) with which the closing element (6) can be moved from the at least one opening position into the closed position.

7. The valve apparatus according to claim 1, whereby the valve apparatus (4) comprises a sensor element or a seal with which an occurred opening of the closing element (6) can be indicated.

8. The valve apparatus according to claim 1, whereby the valve apparatus (4) comprises at least one damping element with which an action of force can be damped upon a change of the closing element (6) between the positions.

9. The valve apparatus according to claim 1, whereby the valve apparatus (4) comprises a stabilizing element (16) with which, among other things, the frame element (7) can be stabilized, in particular against mechanical deformations.

10. The valve apparatus according to claim 1, whereby the valve apparatus (4) comprises a filter element with which exiting fluids can be filtered.

11. The valve apparatus according to claim 1, whereby the valve apparatus (4) is provided with a coupling element to which a discharge line for the exiting fluids can be coupled.

12. A housing or transport container for an electrochemical current source, comprising:
a wall structure defining an inner space (5) and having an opening (3) with a magnetic valve apparatus (4) disposed in said opening, said magnetic valve apparatus comprising a valve closing element (6) that closes the opening 3 in a closed position in a pressure-tight manner and opens it in an open position so that fluids can escape from the inner space (5) of the housing, and with at least one magnetic field producer (10, 13, 13′) that fixes the closing element (6) in the closed position in a pressure-sealing manner up to a predetermined excess pressure in the inner space (5) of the housing, and upon achieving or exceeding the predetermined excess pressure it allows a change of the closing element (6) into at least one open position.

13. The housing or transport container according to claim 12, whereby a ratio of opening cross section/dead volume of the inner space (5) of the housing is at least 0.2 cm²/L.

14. (canceled)

15. (canceled)

16. The housing according to claim 12, further comprising an electrochemical current source disposed in said housing.
